(19) United States
(12) Patent Application Publication
(10) Pub. No.: US 2026/0055816 A1
(43) Pub. Date: Feb. 26, 2026

(54) VOID PLUGS AND EXPANDING SEALS FOR GATE VALVES

(71) Applicant: Isolation Equipment Services Inc., Red Deer (CA)

(72) Inventors: Boris Cherewyk, Red Deer (CA); Ed St. George, Red Deer (CA)

(73) Assignee: Isolation Equipment Services Inc., Red Deer (CA)

(21) Appl. No.: 19/300,241

(22) Filed: Aug. 14, 2025

Related U.S. Application Data
(60) Provisional application No. 63/686,559, filed on Aug. 23, 2024.

(51) Int. Cl. F16K 3/20; F16K 3/36

(52) U.S. Cl. CPC F16K 3/20; F16K 3/36

(57) ABSTRACT

A gate valve comprises a first bore having a first seat pocket and a second bore having a second seat pocket. First and second valve seats are configured to be positioned in the first and second seat pockets, respectively. A gate of the gate valve comprises a first side for sealingly engaging with an inner surface of the first valve seat and a second side for sealingly engaging with an inner surface of the second valve seat. The gate is moveable between an open position and a closed position. First and second valve seats comprise biasing mechanisms for providing a sealing force between the inner surface of the valve seats and the gate. The gate valve may further comprise void plugs for reducing space within the internal cavity of the valve. Shims may be used to decrease the clearance at the gate to seat sealing surfaces.

### CROSS-REFERENCE TO RELATED APPLICATIONS

This application claims priority to and benefit from U.S. Provisional Patent Application Ser. No. 63/686,559, filed on Aug. 23, 2024, which is incorporated herein by reference in its entirety.

### FIELD OF THE DISCLOSURE

The present disclosure relates generally to gate valves for oilfield applications, and in particular to gate valves and components to reduce the likelihood of particulate material entering into the internal cavity of gate valves.

### BACKGROUND

Plug and Perf (or limited entry) operations or similar applications where multi-stages are completed generally require surface manifold equipment to be continually manipulated for isolating a section (e.g., a leg or a zone) of a wellbore from other sections to allow stimulation of desired sections. This generally requires remote valves in and/or above the wellbore be opened and closed numerous times to complete all of the stages of each well. For example, numerous valves may be opened and closed in a process referred to as zipper fracking. During pumping operations, sand may migrate into the bodies of valves regardless of whether the valves are open or closed. This sand may accumulate and eventually render the valves inoperative unless pathways are regularly purged with lubricants. Lubricants help to purge the sand out of valve bodies but sand may continuously and quickly reaccumulate. Therefore, significant amounts of purging may be required to stimulate an entire well (which may have 100 or more stages). Further, as the internal diameter of a valve bore increases, so too does the size of the internal body of the valve, making it even more challenging to fully purge sand out of large valves by pumping lubricant.

Further, when valves are refurbished, best efforts may be made to minimize the total clearances between the gate and seat interface. For example, perhaps the clearance at this interface may be maintained to around 0.010 m to 0.025 m. Unfortunately, the proppants used may comprise particles that are less than 0.010 m in size and may therefore gain entry through the clearances. The sand entering inside the internal cavity of a valve may also accumulate between the gate and seat sealing surfaces and when the valve is functioned, scoring damage may occur to these sealing surfaces resulting in valve leakage and potentially costly down time to replacement damaged parts.

There remains a need for improved valves containing mechanisms that effectively provide tighter tolerances.

### SUMMARY

Embodiments disclosed herein relate to a valve, which may be a gate valve operated manually or remotely. The valves may comprise valve seats having biasing mechanisms for generating a more reliable seal at the gate to seat sealing surface and void plugs for isolating and minimizing the valve internals from sand contamination and for increasing the effectiveness of purging particulate with less lubricant thereby minimizing sand migration into the valve cavity thus improving and extending valve performance.

According to a broad aspect of the present disclosure, there is provided a valve seat comprising: an inner surface for sealingly engaging with a gate of a valve; an outer surface opposite the inner surface; and a biasing mechanism; wherein, the valve seat is configured to be positioned in a seat pocket of the valve and wherein, in operation, the biasing mechanism biases the valve seat towards the gate for providing a sealing force between the inner surface of the valve seat and the gate.

In embodiments, the biasing mechanism of the valve seat comprises: an annular groove in the outer surface of the valve seat; a resilient ring configured to be positioned in the annular groove; and a rigid ring configured to be positioned on top of the resilient ring in the annular groove; wherein, in operation, compression of the resilient ring forces the rigid ring towards a shoulder of the seat pocket thereby biasing the valve seat towards the gate.

In embodiments, the resilient ring of the valve seat comprises an elastomer.

In embodiments, the rigid ring of the valve seat comprises a metal.

In embodiments, the rigid ring of the valve seat comprises at least one vent for relieving pressure in the annular groove.

According to a broad aspect of the present disclosure, there is provided a first gate valve comprising: a first bore comprising a first seat pocket and a second bore comprising a second seat pocket, the first and second seat pockets each comprising a respective shoulder; a first valve seat configured to be positioned in the first seat pocket and a second valve seat configured to be positioned in the second seat pocket, the first and second valve seats each comprising a respective inner surface and a respective outer surface opposite the respective inner surface; a gate comprising a first side for sealingly engaging with the inner surface of the first valve seat and a second side for sealingly engaging with the inner surface of the second valve seat, the gate moveable between: an open position, wherein the first bore and second bore are fluidly connected for allowing fluid flow therebetween; and a closed position, wherein the gate substantially prevents fluid flow between the first bore and the second bore; wherein, at least one of the first valve seat and the second valve seat is a valve seat of according to any one of the aspects described above.

In embodiments, the first gate valve further comprising at least one shim positioned between at least one of: the first valve seat and the shoulder of the first seat pocket; and the second valve seat and the shoulder of the second seat pocket.

In embodiments, the at least one shim of the first gate valve comprises a rigid plastic, Teflon® brass, bronze, Nylatron®, steel, or stainless steel.

In embodiments, the first gate valve further comprises: an internal cavity for accepting a lubricant; and one or more void plugs configured to occupy a respective volume in the internal cavity, the one or more void plugs for reducing the amount of the lubricant that can be accepted by the internal cavity.

In embodiments, the one or more void plugs of the first gate valve comprises composite material, rubber, or steel, and an overlay of Teflon®.

In embodiments, the one or more void plugs of the first gate valve is configured to increase the flow rate of the lubricant at the first and second sides of the gate during purging operations.

According to a broad aspect of the present disclosure, there is provided a void plug configured to occupy a volume in an internal cavity of a valve for reducing the amount of a lubricant that can be accepted therein.

In embodiments, the void plug further comprises a composite material, rubber, or steel, and an overlay of Teflon®.

In embodiments, the void plug is further configured to increase the flow rate of the lubricant between one or more clearances in the internal cavity of the valve during purging operations.

According to a broad aspect of the present disclosure, there is provided a second gate valve comprising: a first bore comprising a first seat pocket and a second bore comprising a second seat pocket, the first and second seat pockets each comprising a respective shoulder; a first valve seat configured to be positioned in the first seat pocket and a second valve seat configured to be positioned in the second seat pocket, the first and second valve seats each comprising a respective inner surface and a respective outer surface opposite the respective inner surface; a gate comprising a first side for sealingly engaging with the inner surface of the first valve seat and a second side for sealingly engaging with the inner surface of the second valve seat, the gate moveable between: an open position, wherein the first bore and second bore are fluidly connected for allowing fluid flow therebetween; and a closed position, wherein the gate substantially prevents fluid flow between the first bore and the second bore; an internal cavity for accepting a lubricant; and one or more void plugs configured to occupy a respective volume in the internal cavity for reducing the amount of the lubricant that can be accepted therein; wherein, at least one of the one or more void plugs is a void plug according to any one of the aspects described above.

In embodiments, at least one of the one or more void plugs of the second gate valve comprises a flared end for directing the lubricant, during purging operations, between at least one of: the first side of the gate and the inner surface of the first valve seat; and the second side of the gate and the inner surface of the second valve seat.

In embodiments, at least one of the one or more void plugs of the second gate valve are restrained in the internal cavity with one or more restraints.

In embodiments, at least one of the first valve seat and the second valve seat of the second gate valve is a valve seat according to any one of the aspects described above.

In embodiments, the second gate valve further comprises at least one shim configured to be positioned between at least one of: the first valve seat and the shoulder of the first seat pocket; and the second valve seat and the shoulder of the second seat pocket.

In embodiments, the at least one shim of the second gate valve comprises a rigid plastic, Teflon®, brass, bronze, Nylatron®, steel, or stainless steel.

### BRIEF DESCRIPTION OF THE DRAWINGS

For a more complete understanding of the disclosure, reference is made to the following description and accompanying drawings, in which:

FIG. 1 is side view of a valve according to some embodiments of the present disclosure;

FIG. 2 is a side view of a portion of the valve of FIG. 1, wherein the valve is in a closed position;

FIG. 3 is a side view of a portion of the valve of FIG. 1, wherein the valve is in an open position;

FIG. 4 is cross-section of a valve body according to some embodiments of the present disclosure;

FIG. 5 is a cross-section of two valve seats according to some embodiments of the present disclosure;

FIG. 6 is a cross-section of a biasing mechanism on a valve seat according to some embodiments of the present disclosure.

### DETAILED DESCRIPTION

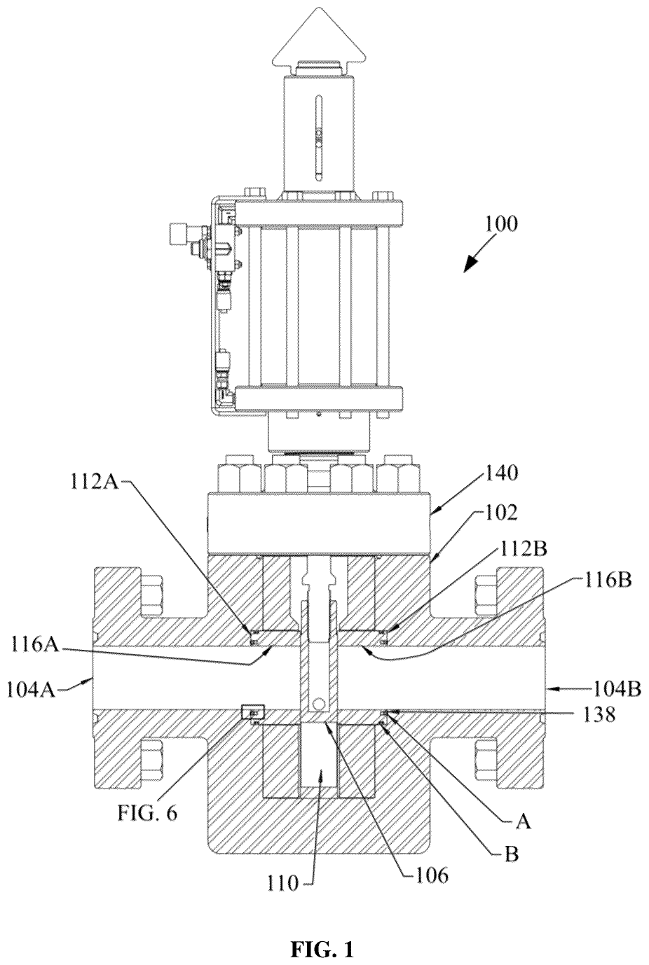

FIG. 1 shows a side view of a remote actuating valve 100 (e.g., a gate valve 100) according to some embodiments of the present disclosure. As shown, gate valve 100 comprises a valve body 102. The valve body 102 comprises a first bore 104A and a second bore 104B, wherein one of the first bore 104A and the second bore 104B may be designated as an inlet of the valve 100 while the other of the first bore 104A and the second bore 104B may be designated as the outlet of the valve 100. The designation may be swapped depending on the specific application. The first bore 104A and the second bore 104B are separated and may be connected or obstructed by a gate 106.

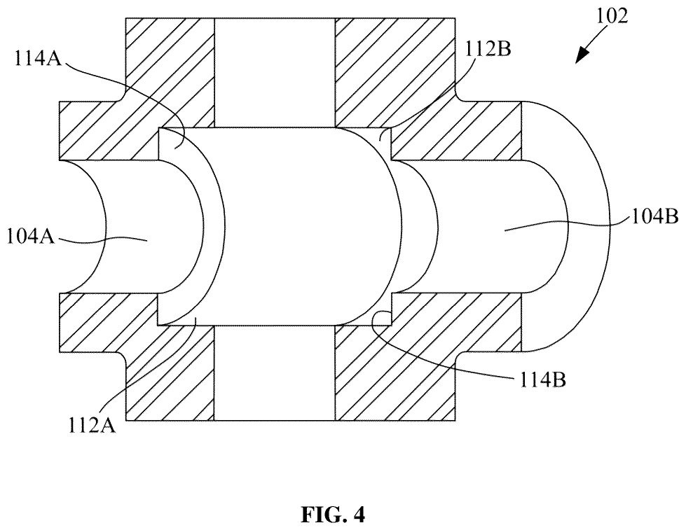

In the illustrated embodiment, the first bore 104A comprises a first seat pocket 112A and the second bore 104B comprises a second seat pocket 112B. The first seat pocket 112A and second seat pocket 112B each comprise a respective shoulder (114A and 114B). The shoulder 114A of first seat pocket 112A and the shoulder 114B of second seat pocket 112B are best seen in FIG. 4, which shows a cross-section of a valve body 102 according to some embodiments of the present disclosure. The first seat pocket 112A is a radially enlarged portion of the first bore 104A that is proximal to the gate 106. In other words, the first seat pocket 112A comprises a larger diameter than the diameter of the first bore 104A. Likewise, second seat pocket 112B is a radially enlarged portion of the second bore 104B that is proximal to the gate 106 (i.e. the second seat pocket 112B comprises a larger diameter than the diameter of the second bore 104B).

Referring back to FIG. 1, in the exemplary embodiment, a first valve seat 116A is configured to be positioned in the first seat pocket 112A and a second valve seat 116B configured to be positioned in the second seat pocket 112B. The first valve seat 116A and second valve seat 116B each comprise a respective inner surface (118A, 118B) and a respective outer surface (120A, 120B) opposite the respective inner surface (118A, 118B).

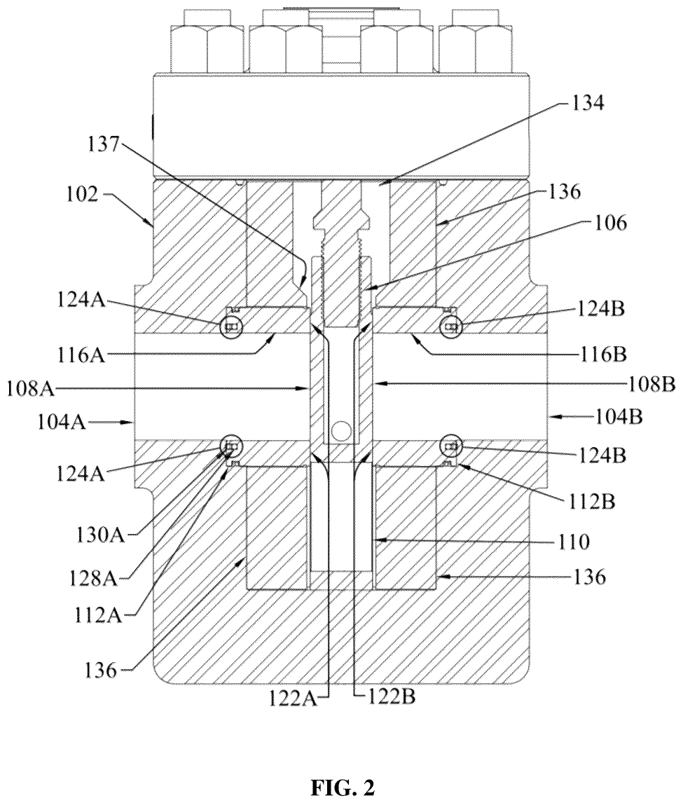

In the exemplary embodiments, as best shown in FIG. 1 and FIG. 2, the gate 106 comprises a first side 108A that faces the flow path of the first bore 104A and a second side 108B that faces the flow path of the second bore 104B. The first side 108A of the gate 106 sealingly engages with the inner surface 118A of the first valve seat 116A. In a similar vein, the second side 108B of the gate 106 sealingly engages with the inner surface 118B of the second valve seat 116B.

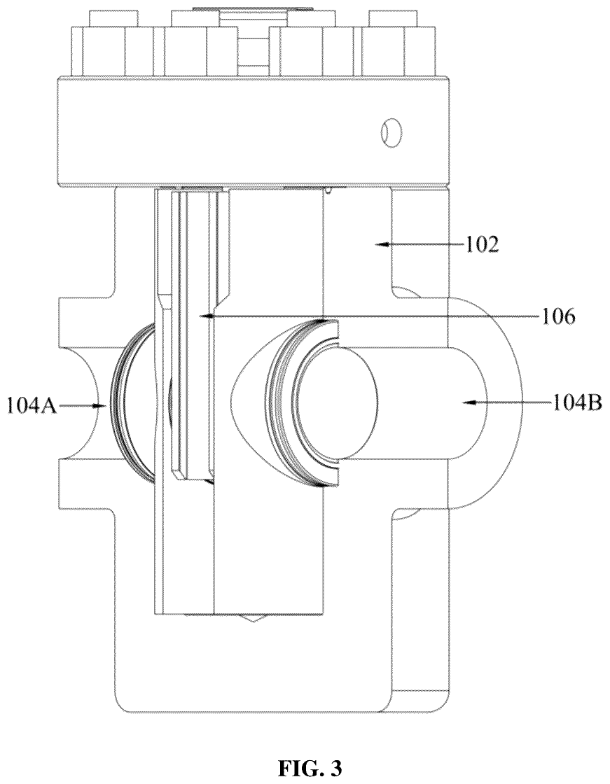

In the illustrated embodiment, the gate 106 is moveable between an open position, wherein the first bore 104A and second bore 104B are fluidly connected for allowing fluid flow therebetween and a closed position, wherein the gate 106 substantially prevents fluid flow between the first bore 104A and the second bore 104B. As used herein, the term “substantially prevents fluid flow” includes complete prevention of fluid flow. FIG. 2 shows a side view of a portion of the remote actuating valve 100 of FIG. 1, wherein the remote actuating valve 100 is in a closed position. FIG. 3 shows a side view of a portion of the remote actuating valve 100 of FIG. 1, wherein the remote actuating valve 100 is in an open position.

In the exemplary embodiment, the first bore 104A and the second bore 104B are separated by a gap. Furthermore, in the exemplary embodiment, the gate 106 comprises a gate bore 110. Referring to FIG. 2, when the gate bore 110 is in a downward position, the gate bore 110 is not aligned with the first bore 104A and the second bore 104B, and the valve 100 is in a closed position. Referring to FIG. 3, when the gate bore 110 is in an upward position, the gate bore 110 is aligned with the first bore 104A and the second bore 104B, and the valve 100 is in an open position, wherein fluid may flow to or from the first bore 104A through the gate bore 110 to or from the second bore 104B. In the open position, the gate bore 110 connects with the first bore 104A at an interface between the first bore 104A and the gate 106 (located at the first side 108A of gate 106) and at an interface between the second bore 104B and the gate 106 (located at the second side 108B of gate 106). In the closed position, fluid flowing to or from the first bore 104A or second bore 104B (as applicable) may be generally interrupted but may leak through clearances into voids in the body 102 of the valve 100.

In the illustrated example, remote actuating valve 100 comprises a gate 106 with a movable gate bore 110. In other embodiments, the gate 106 of remote actuating valve 100 may not comprise a movable gate bore 110. Instead, gate 106 may comprise a disk movable between an open position and a closed position. In either embodiment, gate 106 comprises a first side 108A for sealingly engaging with the inner surface 118A of the first valve seat 116A and a second side 108B for sealingly engaging with the inner surface 118B of the second valve seat 116B.

As shown in FIG. 2, a seal is formed at the first gate to seat sealing surface 122A between the first side 108A of gate 106 and the inner surface 118A of the first valve seat 116A. Likewise, a seal is also formed at the second gate to seat sealing surface 122B between the second side 108B of gate 106 and the inner surface 118B of the second valve seat 116B. In embodiments, seals may be formed at the first and second gate to seat sealing surfaces (122A, 122B) when the gate is in the open position and the closed position. In other embodiments, seals may be formed at the first and second gate to seat sealing surfaces (122A, 122B) when the gate is either in the open position or the closed position.

In some embodiments disclosed herein, gate valve 100 and more specifically, the gate 106 may be operated manually or remote such as through controllers or computing devices. A skilled person is capable of implementing hardware, software, and network structures to enable computer controlled remote operation of remote actuating valves 100 disclosed herein.

In embodiments, remote actuating valve 100 comprises an internal cavity 134. In general, there may be various clearances (i.e. small gaps) between various internal valve components, for example, between first valve seat 116A and first seat pocket 112A, between second valve seat 116B and second seat pocket 112B, and between gate to seat sealing surfaces (122A, 122B). For example, these clearances may be about 0.020 m to 0.030 m. During pumping operation, these clearances may allow particulate, such as sand, to migrate into the valve body 102 and for sand residue to collect on sealing surfaces, for example, between first gate to seat sealing surface 122A and second gate to seat sealing surface 122B. When the valve 100 is functioning, resilient, high impact sand stuck between gate to seat sealing surfaces (122A, 122B) may result in scoring, premature damage to the sealing surfaces of the first and second valve seats 116A, 116B (i.e. the inner surface 118A of first valve seat 116A and the inner surface 118B of first valve seat 116B) and/or first and second sides 108A, 108B of gate 106 which sealingly engage with the first and second valve seats 116A, 116B.

Embodiments disclosed herein relate to gate valves 100 in oilfield applications that may operate remotely or manually. However, a person of skill in the art understands that embodiments disclosed herein and elements or aspects thereof may be used in other types of valves such as plug valves, butterfly valves, ball valves, and/or the like. Features of embodiments of gate valves 100 disclosed herein are for preventing or minimizing particulate, such as sand, from entering the valve cavity 134 during pumping operations whether the valve 100 is in an open or a closed position.

Sand that enters the valve body 102 may accumulate, which results in a requirement for on-going purging using lubricant, grease, and/or the like. Industry accepted greasing units may be capable of pumping grease into cavity 134 of remote actuating valve 100 at high pressures (e.g., up 20,000 psi) in attempt to purge particulate material out valve cavity 134, and in particular, out of clearances between internal valve components (e.g., gate to seat sealing surfaces 122A, 122B). However, pumping grease/lubricant at high pressure into valve cavity 134 may not result in the grease/lubricant flowing at a high velocity in clearances between internal valve components and, therefore, purging operation may be ineffective. As a result of ineffective purging operations, only a partial amount of the sand may be purged out of clearances between internal valve components while a significant portion thereof remains in the valve body 102. Unfortunately, as the sand accumulates and then packs, the ability of a valve 100 to fully open and close is reduced thereby eventually limiting its effective functionality.

In some embodiments of valves 100 disclosed herein, clearances between internal valve components may be reduced by applying and retaining a sealing force on internal elements of the valves 100 to prevent particulate and/or sand migration into the body 102 and into gate to seat sealing surfaces 122A, 122B of the valve 100. In addition, the design of the internal cavity 134 of the valve 100 may be modified to significantly reduce void area resulting in 75% less lubricant required and less opportunity for sand to accumulate in the internal cavity 134 of the valve 100.

Lubricants may range in price from $3.00/lb to $18.00/lb, therefore, the reduction of lubricant not only lowers the maintenance cost per valve 100 but the valve cavity 134 void reduction also increases purging efficiency and requires much less lubricant to “top up” the valve 100 as stages are completed. The top up frequency cycles may also be reduced resulting in efficiencies such as reduced non-productive time. Embodiments of valves 100 provided herein may improve valve performance, reduce top up frequencies by up 500%, and reduce associated lubricant costs for field use and at the time of refurbishing.

The selection of appropriate lubricant may further enhance the effectiveness and efficiency of embodiments of valves 100 disclosed herein. Appropriate lubricants may comprise higher tackiness and viscosity that further reduce any sand migration in clearances between internal components of valve 100 and increases purging efficiency. Finally, appropriate lubricants may exhibit a high degree of anti-seize characteristics.

As noted above, a first valve seat 116A is installed into a first seat pocket 112A and a second a second valve seat 116B is installed into a second seat pocket 112B. In the exemplary embodiment, gate 106 is inserted between the two valve seats 116A, 116B thus forming a seal therebetween to prevent (or substantially prevent) migration of particulate material into valve cavity 134.

Mechanical force may be provided to expand valve seats 116A, 116B towards the gate 106 such that the inner surfaces 118A, 118B of each respective valve seat 116A, 116B continually apply a force onto a respective side 118A, 118B of gate 106. For example, the first valve seat 116A may comprise a first biasing mechanism 124A. When the first valve seat 116A is positioned in the first seat pocket 112A of the valve 100, the first biasing mechanism 124A biases the first valve seat 116A towards the gate 106 for providing a stronger seal (e.g., a sealing force) between the inner surface 118A of the first valve seat 116A and the first side 108A of gate 106 (i.e. at the first gate to seat sealing surface 122A).

Likewise, the second valve seat 116B may comprise a second biasing mechanism 124B and when the second valve seat 116B is positioned in the second seat pocket 112B of the valve 100, the second biasing mechanism 124B biases the second valve seat 116B towards the gate 106 for providing a stronger seal (e.g., a sealing force) between the inner surface 118B of the second valve seat 116B and the second side 108B of gate 106 (i.e. at the second gate to seat sealing surface 122B).

The biasing mechanisms 124A, 124B of valve seats 116A, 116B may allow a stronger sealing engagement (e.g., a sealing force) between gate to seat sealing surfaces 122A, 122B which may help prevent particulate material from migrating into the valve cavity 134.

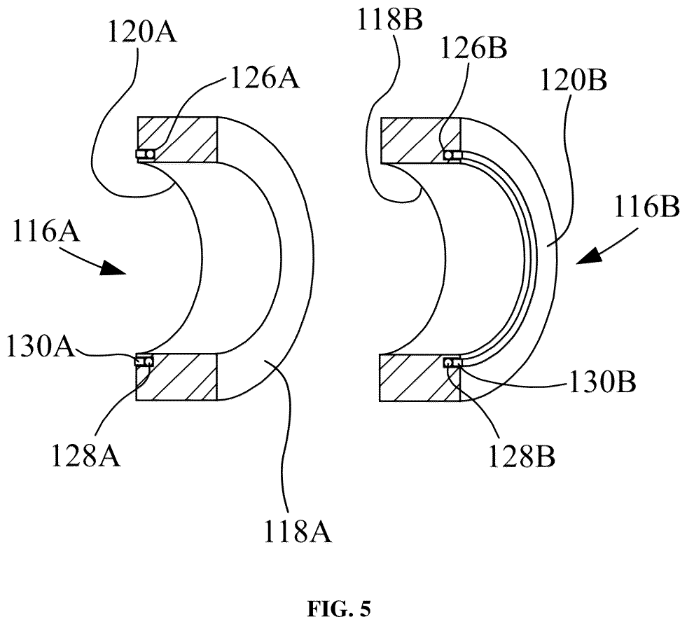

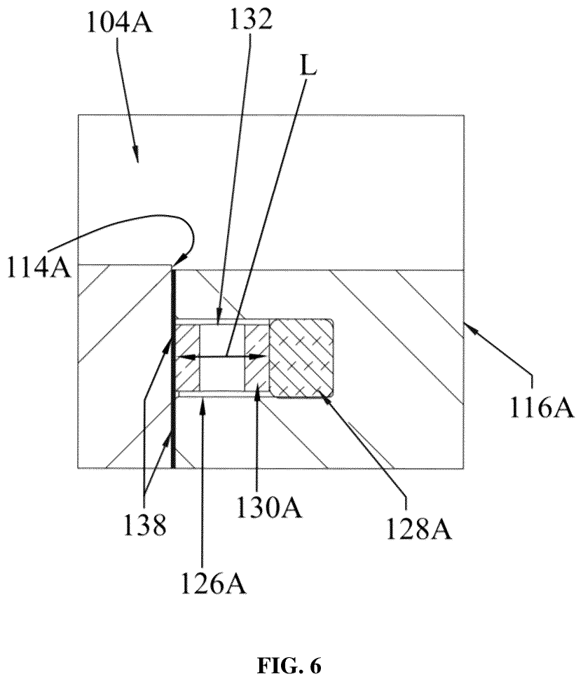

As best shown in FIG. 5 and FIG. 6, in an embodiment, the first biasing mechanism 124A of the first valve seat 116A comprises an annular groove 126A in the outer surface 120A of the first valve seat 116A, a resilient ring 128A configured to be positioned in the annular groove 126A, and a rigid ring 130A configured to be positioned on top of the resilient ring 128A in the annular groove 126A. Likewise, the second biasing mechanism 124B of the second valve seat 116B comprises an annular groove 126B in the outer surface 120B of the second valve seat 116B, a resilient ring 128B configured to be positioned in the annular groove 126B, and a rigid ring 130B configured to be positioned on top of the resilient ring 128B in the annular groove 126B.

In general, first and second valve seats 116A, 116B comprise an annular shape (e.g., see FIG. 5), however, the shape of first and second valve seats 116A, 116B will ultimately depend on the shape of the first and second seat pockets 112A, 112B into which first and second valve seats 116A, 116B are installed. In embodiments, annular grooves 126A, 126B need not comprise a circular perimeter. For example, annular grooves 126A, 126B may comprise a zig-zag or irregular perimeter. Furthermore, in embodiments, annular grooves 126A, 126B may comprise gaps, spaces, or breaks within the groove's perimeter. In this regard, in embodiments, resilient rings 128A, 128B and rigid rings 130A, 130B may comprise a zig-zag or irregular perimeter to match the shape of the annular grooves 126A, 126B. Furthermore, in embodiments, resilient rings 128A, 128B may comprise a plurality of pieces of ring material to fit into gaps, spaces, or breaks within the groove's perimeter. Accordingly, a skilled person will understand that a “ring” may comprise multiple pieces of material and need not be comprise a single unitary component (i.e. resilient rings 128A, 128B and rigid rings 130A, 130B may be formed from a plurality of separate components). Furthermore, a “ring” need not be circular.

At rest (i.e. when the valve seats 116A, 116B are not positioned in their respective seat pockets 112A, 112B), the resilient rings 128A, 128B of each respective valve seat 116A, 116B cause the respective rigid rings 130A, 130B to protrude out of the annular groove 126A, 126B. In other words, due to the biasing force of resilient rings 128A, 128B, at rest, rigid rings 130A, 130B are forced out of their respective annular groove 126A, 126B such that the rigid rings 130A, 130B are not flush with the outer surfaces 120A, 120B of the respective valve seats 116A, 116B.

In operation, the first valve seat 116A is positioned in the first seat pocket 112A. This causes the shoulder 114A of the first seat pocket 112A to push the first rigid ring 130A into the annular groove 126A in the outer surface 120A of the first valve seat 116A resulting in the first resilient ring 128A becoming compressed. Due to its resilience and desire to expand back to its original shape, the compressed first resilient ring 128A applies a force to first rigid ring 130A, which in turn applies a force to the shoulder 114A of the first seat pocket 112A thereby causing the entire first valve seat 116A to be urged towards the first side 108A of gate 106. In a similar manner, in operation, the compressed second resilient ring 128B applies a force to the second rigid ring 130B causing the entire second valve seat 116B to be urged towards the second side 108B of gate 106. Accordingly, the biasing force of the biasing mechanisms 124A, 124B may improve the sealing engagement between valve seats 116A, 116B and gate causing a tighter seal (e.g., a sealing force) at the gate to seat sealing surfaces 122A, 122B.

Biasing mechanisms 124A, 124B may be referred to as ‘expansion seals’ since in operation (i.e. when the valve seat 116A, 116B are positioned in their respective seat pockets 112A, 112B) the resilient rings 128A, 128B are compressed and tend to recoil (i.e. expand) back to their original uncompressed state to generate a sealing force at the gate to seat sealing surfaces 122A, 122B.

The force provided by biasing mechanisms 124A, 124B may be sufficient to reduce and/or close up any clearances between the first and second sides 108A, 108B of gate 108 and the inner surfaces 118A, 118B of the first and second valve seats 116A, 116B, respectively. For example, for assembly purposes, there may be a minimal clearance of 0.010 m at the gate to seat sealing surfaces 122A, 122B. The biasing mechanisms 124A, 124B may exert enough force to close up the 0.010 m gap between the gate to seat sealing surfaces 122A, 122B, thereby preventing sand from migrating into the valve cavity 134. For example, the biasing mechanisms 124A, 124B may force the rigid rings 130A, 130B towards a respective shoulder 114A, 114B of a respective seat pocket 112A, 112B causing each valve seat 116A, 116B to be biased towards the gate 106. Therefore, the biasing action of biasing mechanisms 124A, 124B may cause the valve seats 116A, 116B to apply a compressive sealing force on each respective side 108A, 108B of the gate 106, resulting in a tighter isolating seal.

In some embodiments, the first and second resilient rings 128A, 128B of biasing mechanisms 124A, 124B may comprise a resilient elastomer, rubber, urethane, and/or the like. In some embodiments, the rigid rings 130A, 130B may comprise a material strong enough to withstand considerable force and not extrude. For example, rigid rings 130A, 130B may comprise a metal, a metal alloy, graphite, brass and/or the like.

In embodiments, during assembly, prior to the gate 106 being assembled between the valve seats 116A, 116B, special tooling may be used to manipulate the valve seats 116A, 116B firmly into position against their respective seat pockets 112A, 112B. Once the gate 106 is aligned and starts to enter the seat area, the tooling may be then removed and the gate 106 may be forced into position. In embodiments, using the tooling, even more compressive sealing force can be achieved at the gate to seat sealing surfaces 122A, 122B.

In embodiments disclosed herein, whether the valve 100 is in an open or a closed position, each valve seats 116A, 116B is biased toward a respective gate to seat sealing surface 122A, 122B. For example, the biasing force from each biasing mechanism 124A, 124B may cause each valve seats 116A, 116B to be pushed away from a respective shoulder 114A, 114B of a respective seat pocket 112A, 112B by about 0.050 m. Thus, in embodiments, both valve seats 116A, 116B will be biased towards a respective side 108A, 108B of gate 106 and may close up any clearances at the gate to seat sealing surface 122A, 122B. Furthermore, in embodiments, biasing mechanisms 124A, 124B may cause inner surfaces 118A, 118B of each valve seat 116A, 116B to exert a compressive sealing force on each respective side 108A, 108B of gate 106 causing a tighter seal to form at the gate to seat sealing surfaces 122A, 122B.

In some embodiments of the present disclosure, the biasing mechanisms 124A, 124B may be a spring mechanism to push each valve seat 116A, 116B towards a respective side 108A, 108B of gate 106.

FIG. 5 shows a cross-section of two valve seats 116A, 116B according to some embodiments of the present disclosure. The first valve seat 116A comprises an inner surface 118A (i.e. sealing surface) for sealing against the first side 108A of gate 106. Similarly, the second valve seat 116B comprises an inner surface 118B (i.e. sealing surface) for sealing against the second side 108B of gate 106. The first valve seat 116A also comprises an outer surface 120A which, in operation, is installed proximal to a first shoulder 114A of the first seat pocket 112A. Likewise, the second valve seat 116B also comprises an outer surface 120B which, in operation, is installed proximal to a second shoulder 114B of the second seat pocket 112B.

As shown in FIG. 5, each valve seat 116A, 116B comprises a respective biasing mechanism 124A, 124B, namely: an annular groove 126A, 126B on the outer surface 120A, 120B of each valve seat 116A, 116B, a resilient ring 128A, 128B within each respective annular groove 126A, 126B, and a rigid ring 130A, 130B on top of each respective resilient ring 128A, 128B.

FIG. 6 shows a cross-section of the first biasing mechanism 124A of the first valve seat 116A according to some embodiments of the present disclosure. In embodiments, the second biasing mechanism 124B of the second valve seat 116B may be the same as the first biasing mechanism 124A shown in FIG. 6. In other embodiments, only one of the valve seats 116A, 116B comprises a respective biasing mechanism 124A, 124B. In other embodiments, the first and second valve seats 116A, 116B comprise different biasing mechanisms 124A, 124B. A skilled person will understand that the description of FIG. 6 below may apply with similar logic to a second biasing mechanism 124B of a second valve seat 116B.

As shown in FIG. 1, FIG. 6 is a close up of the first biasing mechanisms 124A of first valve seat 116A, when the valve seat 116A is in an operational configuration (i.e. when valve seat 116A is positioned in first seat pocket 112A).

As shown in FIG. 6, in an exemplary embodiment, first biasing mechanism 124A may comprise a resilient O-ring 128A positioned in machined groove 126A in the outer surface 120A of first valve seat 116A face and a rigid ring 130A on top of the resilient O-ring 128A. The rigid ring 130A may comprise bronze or aluminum bronze. The depth of the machined groove 123A may be adjusted and the durometer of the resilient O-ring 128A selected to provide desired resistance and compression. For example, with a higher durometer, the resilient O-ring 128A is more rigid with a higher tensile strength. A skilled person will be able to select an appropriate durometer rating for O-ring 128A to provide a balance between compressibility (for facilitating easy installation of first valve seat 116A into first seat pocket 112A) and resilience or ability to recoil and expand from a compressed state (for pushing first valve seat 116A towards the first side 108A of gate 106 and providing an appropriate compressive sealing force at the first gate to seat sealing surface 122A).

In the embodiment shown in FIG. 6, rigid ring 130A may be located within the machined groove 126A. In embodiments, the rigid ring 130A may be perforated with a vent 132 at about the midpoint of the body of rigid ring 130A for venting pressure in the annular groove 126A. The vent 132 may help prevent damage to resilient ring 128A caused by pressure build up in the annular groove 126A. In embodiments, rigid ring 130A may comprise a plurality of vents.

At rest (i.e. when the first valve seat 116A is not installed within the first seat pocket 112A), the rigid ring 130A may protrude 0.060 m out of the first valve seat 116A. During installation, the first valve seat 116A is installed within the first seat pocket 112A and the gate 106 is inserted between the two seats 116A, 116B to rest therebetween. The leading edge of the gate 106 may be tapered and/or rounded to facilitate entry of the gate 106 between the two seats 116A, 116B. In operation, when gate 106 is installed between seats 116A, 116B, by virtue of the first valve seat 116A being positioned between the shoulder 114A of first seat pocket 112A and the first side 108A of the gate 106, the rigid ring 130A causes resilient O-ring 128A to collapse, allowing rigid ring 130A to embed into the groove 126A. In its collapsed (compressed) state, resilient O-ring 128A is energized and exerts an elastic expansion force to push the rigid ring 130A toward the shoulder 114A of the first seat pocket. In turn, this causes the first valve seat 116A to be pushed (i.e. biased) towards the first side 108A of gate 106, thereby eliminating clearance space between the inner surface 118A of first valve seat 116A and the first side 108A of gate 106. Elimination of clearance helps prevent sand or other particulate material from entering the valve cavity 134.

For example, in an embodiment, there may be a clearance of 0.060 m between the first side 108A of gate 106 and the inner surface 118A of first valve seat 116A. In embodiments, first biasing mechanism 124A may bias the first valve seat 116A toward the first side 108A of gate 106 by around 0.070 m, thus closing any clearance between the first side 108A of gate 106 and the inner surface 118A of first valve seat 116A and also providing a compressive sealing force to be maintained therebetween, resulting in a tighter (i.e. stronger and more reliable) seal at the first gate to seat sealing surface 122A.

With further reference to FIG. 6, by manipulating the length L of rigid ring 130A, the expansion force (i.e. biasing force) exerted by the resilient O-ring 128A may be increased and consequently cause more compressive sealing force to be applied between the first side 108A of the gate 106 and the inner surface 118A of the first valve seat 116A resulting in a tighter seal at gate the gate to seat sealing surface 122A. This can further improve the prevention of sand migration into the internal cavity 134 of valve 100.

For example, increasing the length L of rigid ring 130A by as little as 0.020 m may result in a larger sealing force applied to gate to seat sealing surface 122A. Depending on how far rigid ring 130A protrudes outwardly from the outer surface of 120A of valve seat 116A when the first valve seat 116A is at rest (i.e. when the first valve seat 116A is not installed in the first seat pocket 112A), tooling may be required to retract first valve seat 116A into the first seat pocket 112A. The valve bonnet 140 and/or elongated studs thereabove may be used as a leverage point to assist in the installation of first valve seat 116A into the first seat pocket 112A. In light of this disclosure, a skilled person is able to select or manufacture a rigid ring 130A with appropriate dimensions to enable installation of first valve seat 116A into the first seat pocket 112A while also allowing the inner surface 118A of first valve seat 116A to apply a compressive sealing force against the first side 108A of gate 106.

As noted above, vent 132 relieves pressure in the annular groove 126A and, therefore, prevents a seal from forming at the interface between the outer surface 120A of the first valve seat 116A and the shoulder 114A of the first seat pocket 112A (i.e. proximal to shim 138 shown in FIG. 6). Thus, the principal purpose of biasing mechanism 124A, is not in itself to act as a seal, but rather, as a mechanism to apply a compressive sealing force at the opposite side of the first valve seat 116A, namely, between the inner surface 118A of the first valve seat 116A and the first side 108A of gate 106 to enable a better seal between gate to seat sealing surface 122A.

A skilled person will appreciate that resilient O-ring 116A may comprise various shapes and need not be circular or have an “O” shape. For example, resilient O-ring 116A may comprise a flexible square or rectangle material. In other embodiments, resilient O-ring 116A may comprise several pieces of resilient material that fit into a disjointed annular groove 126A in the outer surface 120A of the first valve seat 116A.

Ultimately, first biasing mechanism 124A is compressive enough to allow gate 106 to fit between valve seats 116A, 116B during installation, while maintaining sufficient resilience to force valve seats 116A, 116B towards gate 106 during operation, thereby maintaining sealing engagement at the gate to seat sealing surfaces 122A, 122B thus preventing sand from migrating in the internal cavity 134 of valve 100 during pumping operations.

In some embodiments, rigid ring 130A is composed of rigid plastic, Teflon®, brass, bronze, Nylatron®, steel or stainless steel.

To reiterate, a skilled person will understand that the description of FIG. 6 above may apply with similar logic to a second biasing mechanism 124B of a second valve seat 116B.

In some embodiments, mechanical devices may be inserted into the valve bores (i.e. the first valve bore 104A and the second valve bore 104A) to pull the valve seats 116A, 116B towards a shoulder 114A, 114B of a respective seat pocket 112A, 112B. Such a mechanical devices may allow installation of the gate 106 between the two seats 116A, 116B. Once the gate 106 is in position, the devices may be removed. This may be done is combination or in the alternative to the tapered or rounded leading edge of the gate 106. The mechanical devices may comprise a mechanical drive from a source such as hydraulic, air cylinder, screw drive and/or the like to assist in achieving gate 106 entry between the valve seats 116A, 116B. In some embodiments, a gate 106 that fits very tightly between seats 116A, 116B and that requires the use of a mechanical device to install the gate 106 between the seats 116A, 116B may assist in achieving an even higher degree of compression force on the first and second sides 108A, 108B of gate 106 thereby further improving the seal between gate to seat sealing surfaces 122A, 122B. In other embodiments, gate 106 comprises a moving disc and inner surfaces 118A, 118B of valve seats 116A, 116B are engaged with a first and second side 108A, 108B, respectively, of the gate disc when the gate 106 is in the closed position.

In embodiments, valve seats 116A, 116B are comprised of a resilient material permitting a level of compression to allow gate 106 entry between the seats 116A, 116B. Accordingly, in embodiments, due to resilience of seats 116A, 116B (i.e. the ability of seats 116A, 116B to compress and recoil to their original shape) a mechanical device may not be needed for installation of the gate 106 between seats 116A, 116B. Furthermore, in embodiment, seats 116A, 116B comprised of resilient material may increase the compression load applied to first and second sides 108A, 108B of gate 106 thereby further improving the sealing engagement at gate to seat sealing surfaces 122A, 122B.

In light of the above description a skilled person will appreciate that the resilient rings 128A, 128B of biasing mechanisms 124A, 124B may comprise a resilient material to force the first valve seat 116A towards the first side 108A of gate 106 and to force the second valve seat 116B towards the second side 108B of gate 106. In embodiments, biasing mechanisms 124A, 124B may cause an equal force to be maintained on each side 108A, 108B of gate 106. In other embodiments, differing force may be maintained on each side 108A, 108B of gate 106. In other embodiments, a biasing force is only applied to the first side 108A or the second side 108B of the gate 106.

Based on the size of the valve 100, the size of valve seats 116A, 116B, the size of the gate 106, and other factors, a skilled person is capable of designing and selecting an appropriately material of appropriate size and shape for the resilient rings 128A, 128B and the rigid rings 130A, 130B to permit a desired compressive force on each side 108A, 108B of gate 106. For example, a skilled person is capable of selecting an appropriate durometer rating for the resilient rings 128A, 128B so that the resilient rings 128A, 128B exert an appropriate expansion force when the valve seats 116A, 116B are installed into their respective seat pockets 112A, 112B.

As noted above, resilient rings 128A, 128B may comprise separate pieces of elastomeric material (not a single piece material) the separate pieces capable of being arranged around a general ring shape annular groove 126A, 126B around the outer surfaces 120A, 120B of valve seats 116A, 116B. In other words, each annular groove 126A, 126B may comprise a plurality of irregular shaped grooves separated by gaps or spaces, the plurality of spaced apart grooves collectively defining a general ring shape.

Referring back to FIG. 2, in embodiments, the valve 100 may comprise an internal cavity 134 for accepting a lubricant, for example, from a lubricant injector. In embodiments, the lubricant may be grease. Valve 100 may further comprise one or more void plugs 136 configured to occupy a respective volume in the internal cavity 134 of valve 100 for reducing the amount of the lubricant that can be accepted therein. Depending on the lubricant that is used, a range of associated costs may be reduced through the use of void plugs 136. Further, depending on a configuration used, wherein for example six to twelve valves 100 can be used per well leg, lubricant costs may be reduced substantially with the use of void plugs 136. With the use of void plugs 136, in some embodiments, up to about 80% less lubricant may be used.

In some embodiments, void plugs 136 may be machined such that one part occupies more of the void space in the cavity 134 of the valve 100 than another part. For example, with reference to FIG. 2, the void plugs 136 below the valve seats 116A, 116B may comprise relatively more material than the void plugs 136 above the valve seats 116A, 116B. Further, in embodiments, the void plugs 136 above the valve seats 116A, 116B may comprise a flared end 137 proximal to outer perimeter of valve seats 116A, 116B to direct lubricant between the inner surfaces 118A, 118B of the valve seats 116A, 116B and a respective side 108A, 108B of the gate. Thus, the flared end 137 of void plugs 136 may increase the flow rate of the lubricant at the first and second sides of the gate during purging operations, thereby improving the effectiveness of purging operations. In other embodiments, the shape of void plugs 136 may be designed to increase the flow rate of the lubricant between one or more other clearances between internal components in the internal cavity 134 of the valve 100 during purging operations. Overall, dimensions of the void plugs 136 and the installation position of the void plugs 136 in the internal cavity 134 of the valve 100 are intended to maximize lubricant purging and efficiency.

The void plugs 136 may also provide support for the gate 106 as it transitions from open to closed position or vice-versa. Void plugs 136 may effectively reduce clearance spaces between internal components in the valve 100, for example, to clearances of 0.050 m or smaller. This reduced clearance allows the lubricant to provide a higher purge force to remove particulate or sand from the internal cavity 134 of valve 100. Without the void plugs 136m it may be very difficult to obtain a complete purge, as the lubricant will take the path of least resistance. Void plugs 136 may be shaped to allow an equal or near equal purging efficiency across all clearances between internal components in cavity 134 of valve 100 (for example, by making the size of all void spaces within a certain range).

During oilfield operations in the winter, fracturing fluids such a water may enter the valve body 102 and the cavity 134 of valve 100 which requires extensive purging. Using void plugs 136, the void areas in the cavity 134 of valve 100 may be significantly reduced thereby reducing the amount of water and/or sand slurry to enter the cavity 134 of valve 100, and this minimal amount of water and/or sand slurry can be quickly and efficiently purged out with lubricant, non-freezing liquids, and/or the like.

In some embodiments of the present disclosure, the void plug 136 may comprise a composite material, rubber, steel, steel with an optional Teflon® or similar overlay to prevent damage to the gate to seat sealing surface 122A, 122B as the gate 106 slides along the void plugs 136 when transitioning from the open to closed positions, or vice-versa. Furthermore, Teflon® may provide a smooth interface between a gate 106 and void plug 136, aiding in the distribution of grease through clearances and may make void plugs 136 less prone to corrosion.

Void plugs 136 may be retained in position in internal cavity 134 of valve 100 by an interference fit. Alternatively, one or more restraints may be used to restrain void plugs 136 in internal cavity 134 of valve 100. The void plug 136 restraint may comprise a ring with protrusions (e.g., prongs or fingers) connected to circumference of the ring. The protrusions may protrude perpendicularly, or generally perpendicularly, with respect to a plane defined by the area between the restraining ring. A restraining ring with multiple protrusions may restrain more than one void plug 136.

In another embodiment, void plugs 136 may be restrained to the cavity 134 of valve 100 using spring pins. For example, spring pins may be set into the void plugs 136 and match holes drilled in the internal cavity 134 where void plugs 136 are to be installed. Alternatively, internal cavity 134 may comprise spring pins and void plugs 136 may comprise holes into which the spring pins fit.

In another embodiment, void plugs 136 may be restrained to the cavity 134 of valve 100 by an interference fit, for example, by using a flared end 137 at the bottom of the void plugs 136 that fits into a corresponding channel in the valve cavity 134.

In another embodiment, void plugs 136 and valve cavity 134 may comprise alignable slots or holes, which when aligned, a pin may be inserted through the aligned slots or holes to secure void plugs 136 to the cavity 134 of valve 100.

In other embodiments, a plurality of different restraining mechanisms are used to restrain void plugs 136 and valve cavity 134. In light of the above disclosure, a skilled person is aware of other suitable restraining mechanisms other than those described above.

Void plug restraints can assist in achieve proper positioning of void pugs 136. A skilled person will appreciate that void plugs 136 can be modified to be a different shape than that shown in the exemplary Figures. The shape of void plugs 136 will be designed to fill in internal voids of valves 100 and, thus, the shape of void plugs 136 may be valve dependent. In embodiments, void plugs 136 may be shorter than void plugs 136 shown in the exemplary Figures. For example, in embodiments, void plugs 136 may extend from the bottom of the valve 100 to the bottom edge of first and second valve seats 116A, 116B. In yet another example, void plugs 136 may not extend to the bottom of the valve 100, thereby permitting a small space for sand and other contaminants to accumulate, while not adversely affect the performance of the valve 100.

The use of void plugs 136 may provide many advantages such as reducing the volume of lubricant or grease required to initially fill the internal cavity 134 of valve 100 for field use and reducing the volume of lubricant or grease required to purge and replenish the valve 100 when used for multiple stages in the field. Furthermore, in embodiments, void plugs 136 reduce the amount of void space near portions of the first and second sides 108A, 108B of gate 106, and this reduced void space can cause a higher lubrication flow rate at the first and second sides 108A, 108B of gate 106 to provide an efficient flow of lubricant for purging out particulate and/or sand that has migrated into sealing areas. Further, the use of void plugs 136 may reduce the time required to replenish and purge the valve 100. For example, using void plugs 136, purging or lubrication replenishing operations may be reduced from an average of four to eight minutes (depending on the size and pressure rating of the valve body 102) to sixty to ninety seconds. Such a time savings may add up over an entire leg of a well that may have six to twelve valves 100 to significant time savings and increased efficiency.

For example, most well pads have at least two legs (and often six or more legs) meaning that each well pad requires significant valve lubrication. Further, without void plugs 136, replenishing grease may end up anywhere other than the critical area interface between the first and second sides 108A, 108B of gate 106 and inner surfaces 118A, 118B of valve seats 116A, 116B (i.e. gate to seat sealing surface 122A, 122B). Thus, using void plugs 136 may allow for more effective lubricant replenishing operations.

Generally, grease pumps are high-pressure pumps capable of pumping grease at up to 20,000 psi, however, such pumps can often only pump 0.5 L/min to 1 L/min. This slow pumping velocity may cause a narrow (river) path of least resistance and only effectively purge sand (or other particulate material) from a small area. Furthermore, standard pump fittings in the industry may may also target high pressure grease only in certain areas of the internal cavity 134 of the valve 100. Therefore, by typical industry design, the grease flow rate may be insufficient to purge particulate material from the internal cavity 134 of valves 100 having large valve bodies 102, for example, internal cavities 134 capable of accepting 10-20 litres of grease.

When a valve 100 is closed and subjected to pressures as high a 15,000 psi, the forces applied to the valve 100 are extreme and if sand is caught between the gate to seat sealing surfaces 122A, 122B, score damage to the inner surfaces 118A, 118B of valve seats 116A, 116B and/or the first and second sides 108A, 108B of gate 106 may occur, such damage occurring with even greater risk if the valve 100 is functioned without performing pressure equalization. Accordingly, replacement parts may be required to replace worn down parts of valve 100.

However, such replacement parts may be extremely expensive and therefore it is common to restore the parts. For example, to restore gate to seat sealing surfaces 122A, 122B, the first and second sides 108A, 108B of gate 106 are generally surface ground to remove damage and then lapped to restore the finish to new a condition. Such a process may remove approximately 0.005 m to 0.010 m from each of the first and the second sides 108A, 108B of gate 106 (to a total of approximately 0.010 m to 0.020 m).

In embodiments, restored valve seats 116A, 116B and the restored gate 106 may exhibit an overlay of material at the gate to seat sealing surfaces 122A, 122B, wherein such overlay of material is harder and more resilient material to sand abrasion. For example, inner surfaces 118A, 118B of valve seats 116A, 116B and/or the first and second sides 108A, 108B of gate 106 may comprise an overlay of Teflon® or like material.

Additionally, or in the alternative, as shown in FIG. 6, to minimize total clearance at the gate to seat sealing surfaces 122A, 122B, and to prevent sand migration therebetween, in some embodiments of the present disclosure, shims 138 may be inserted at interfaces between the outer surface 120A of first valve seat 116A and the shoulder 114A of the first seat pocket 112A as well as the outer surface 120B of second valve seat 116B and the shoulder 114B of the second seat pocket 112B.

For example, shims 138 having a thickness of 0.010 m may be inserted between valve seat 116A, 116B and a shoulder 114A, 114B of a respective seat pockets 112A, 112B, to compensate for the removal of material that has been ground off from the sides 108A, 108B of the gate 106. In some embodiments of the present disclosure, the shims 138 may be a flat ring and may comprise a rigid plastic, Teflon®, brass, bronze, Nylatron®, steel, stainless steel and/or the like. Alternatively, shims 138 may comprise a metallic or plastic material and comprise an overlay of Teflon®.

For example, gate 106 and gate to seat sealing surface 122A, 122B may become scored or damaged during use. During repair, first and second sides 108A, 108B of gate 106 may be smoothed or grinded removing some material, such as 0.005 to 0.010 m to restore gate to seat sealing surface 122A, 122B to an appropriate finish wherein first and second sides 108A, 108B of gate 106 may be buffed or lapped to a mirror finish for obtaining seals. As material may be removed during this process, one or more shims 138 may be inserted at the interface between the outer surface 120A of first valve seat 116A and the shoulder 114A of the first seat pocket 112A as well as the outer surface 120B of second valve seat 116B and the shoulder 114B of the second seat pocket 112B to replace the removed material (e.g., see shim 138 in FIG. 6). This may be done instead of replacing the entire gate 106 and/or valve seats 116A, 116B, which may be expensive and wasteful.

A skilled person will appreciate that shims 138 may be variety of shapes and selected to have an appropriate thickness in the circumstances. Furthermore, shims 138 are optional and need not be used where the tolerances between the valve seats 116A, 116B and first and second sides 108A, 108B of gate 106, respectively, are sufficiently small resulting in a sufficient seal at gate to seat sealing surfaces 122A, 122B. In other words, when biasing mechanisms 124A, 124B of valve seats 116A, 116B apply a sufficient compressive sealing force against the first and second sides 108A, 108B of gate 106, shims 138 may not be needed.

Many manufacturers design valves such that the valve seats comprise a corner seal (e.g., at position A in FIG. 1). By placing the seal in the position B location shown in FIG. 1 (instead of the position A location), operators may insert the shims 138 without compromising the valve seat's 116A, 116B ability to also act as a seal near the shoulders 114A, 114B of the seat pockets 112A, 112B.

A skilled person will understand that a gate valve 100 comprising a combination of valve seats 116A, 116B containing biasing mechanisms 124A, 124B, void plugs 136, and shims 138, can reduce valve maintenance costs and result in longer valve lifespan.

In light of the above disclosure, also provided are methods of positioning one or more shims 138 between at least one of: a first valve seat 116A and a shoulder 114A of a first seat pocket 112A of a gate valve 100 and a second valve seat 116B and a shoulder 114B of a second seat pocket 112B of the gate valve 100. For example, the one or more shims may be positioned between the outer surface 120A of a first valve seat 116A and a shoulder 114A of a first seat pocket 112A of a gate valve 100 and/or between the outer surface 120B of a second valve seat 116B and a shoulder 114B of the second seat pocket 112B of the gate valve 100.

Additionally, in embodiments, the method further comprises grinding down material from a first side 108A of a gate 106 and/or a second side 108B of a gate 106, prior to installing the one or more shims.

In embodiments, the method of positioning one or more shims 138 reduces the clearance space between at least one of: the first side 108A of the gate 106 and the inner surface 118A of the first valve seat 116A, and the second side 108B of the gate 106 and the inner surface 118B of the second valve seat 116B. In embodiments, the one or more shims 138 comprises a rigid plastic, Teflon®, brass, bronze, Nylatron®, steel, or stainless steel.

Embodiments have been described above in conjunctions with aspects of the present invention upon which they may be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Unless otherwise defined, all technical and scientific terms used herein generally have the same meaning as commonly understood by one of ordinary skill in the art to which this disclosure pertains.

The term “a” or “an” refers to one or more of that entity; for example, “a module” refers to one or more modules or at least one module. As such, the terms “a” (or “an”), “one or more” and “at least one” are used interchangeably herein. In addition, reference to an element or feature by the indefinite article “a” or “an” does not exclude the possibility that more than one of the elements or features are present, unless the context clearly requires that there is one and only one of the elements. Furthermore, reference to a feature in the plurality (e.g., modules), unless clearly intended, does not mean that the modules or methods disclosed herein must comprise a plurality.

The expression “and/or” refers to and encompasses any and all possible combinations of one or more of the associated listed items (e.g. one or the other, or both), as well as the lack of combinations when interrupted in the alternative (or).

Although the present invention has been described with reference to specific features and embodiments thereof, it is evident that various modifications and combinations may be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A valve seat comprising:
an inner surface for sealingly engaging with a gate of a valve;
an outer surface opposite the inner surface; and
a biasing mechanism;
wherein, the valve seat is configured to be positioned in a seat pocket of the valve and wherein, in operation, the biasing mechanism biases the valve seat towards the gate for providing a sealing force between the inner surface of the valve seat and the gate.

2. The valve seat of claim 1 wherein the biasing mechanism comprises:
an annular groove in the outer surface of the valve seat;
a resilient ring configured to be positioned in the annular groove; and
a rigid ring configured to be positioned on top of the resilient ring in the annular groove;
wherein, in operation, compression of the resilient ring forces the rigid ring towards a shoulder of the seat pocket thereby biasing the valve seat towards the gate.

3. The valve seat of claim 2, wherein the resilient ring comprises an elastomer.

4. The valve seat of claim 2, wherein the rigid ring comprises a metal.

5. The valve seat of claim 2, wherein the rigid ring comprises at least one vent for relieving pressure in the annular groove.

6. A gate valve comprising:
a first bore comprising a first seat pocket and a second bore comprising a second seat pocket, the first and second seat pockets each comprising a respective shoulder;
a first valve seat positioned in the first seat pocket and a second valve seat positioned in the second seat pocket, the first and second valve seats each comprising a respective inner surface and a respective outer surface opposite the respective inner surface;
a gate comprising a first side for sealingly engaging with the inner surface of the first valve seat and a second side for sealingly engaging with the inner surface of the second valve seat, the gate moveable between:
an open position, wherein the first bore and second bore are fluidly connected for allowing fluid flow therebetween; and
a closed position, wherein the gate substantially prevents fluid flow between the first bore and the second bore;
wherein, the first valve seat further comprises a biasing mechanism for biasing the first valve seat towards the gate and for providing a sealing force between the inner surface of the first valve seat and the first side of the gate.

7. The gate valve of claim 6 further comprising at least one shim positioned between the first valve seat and the shoulder of the first seat pocket.

8. The gate valve of claim 7, wherein the at least one shim comprises a rigid plastic, Teflon®, brass, bronze, Nylatron®, steel, or stainless steel.

9. The gate valve of claim 6 further comprising:
an internal cavity for accepting a lubricant; and
one or more void plugs configured to occupy a respective volume in the internal cavity, the one or more void plugs for reducing the amount of the lubricant that can be accepted by the internal cavity.

10. The gate valve of claim 9, wherein the one or more void plugs comprise composite material, rubber, or steel, and an overlay of Teflon®.

11. The gate valve of claim 9, wherein at least one of the one or more void plugs is configured to increase the flow rate of the lubricant at the first and second sides of the gate during purging operations.

12. A void plug configured to occupy a volume in an internal cavity of a valve for reducing the amount of a lubricant that can be accepted therein.

13. The void plug of claim 12 further comprising a composite material, rubber, or steel, and an overlay of Teflon®.

14. The void plug of claim 12, further configured to increase the flow rate of the lubricant between one or more clearances in the internal cavity of the valve during purging operations.

15. A gate valve comprising:
a first bore comprising a first seat pocket and a second bore comprising a second seat pocket, the first and second seat pockets each comprising a respective shoulder;
a first valve seat positioned in the first seat pocket and a second valve seat positioned in the second seat pocket, the first and second valve seats each comprising a respective inner surface and a respective outer surface opposite the respective inner surface;
a gate comprising a first side for sealingly engaging with the inner surface of the first valve seat and a second side for sealingly engaging with the inner surface of the second valve seat, the gate moveable between:
an open position, wherein the first bore and second bore are fluidly connected for allowing fluid flow therebetween; and
a closed position, wherein the gate substantially prevents fluid flow between the first bore and the second bore;
an internal cavity for accepting a lubricant; and
one or more void plugs configured to occupy a respective volume in the internal cavity for reducing the amount of the lubricant that can be accepted therein.

16. The gate valve of claim 15, wherein at least one of the one or more void plugs comprises a flared end for directing the lubricant, during purging operations, between at least one of:
the first side of the gate and the inner surface of the first valve seat; and
the second side of the gate and the inner surface of the second valve seat.

17. The gate valve of claim 15, wherein at least one of the one or more void plugs are restrained in the internal cavity with one or more restraints.

18. The gate valve of claim 15, wherein the first valve seat further comprises a biasing mechanism for biasing the first valve seat towards the gate and for providing a sealing force between the inner surface of the first valve seat and the first side of the gate.

19. The gate valve of claim 15, further comprising at least one shim positioned between the first valve seat and the shoulder of the first seat pocket.

20. The gate valve of claim 19, wherein the at least one shim comprises a rigid plastic, Teflon®, brass, bronze, Nylatron®, steel, or stainless steel.
